(19) United States
(12) Patent Application Publication
(10) Pub. No.: US 2017/0363150 A1
(43) Pub. Date: Dec. 21, 2017

(54) Torsional Damper With Angular-Dependent Friction Damping Device

(71) Applicant: ZF Friedrichshafen AG, Friedrichshafen (DE)

(72) Inventor: Dominik BÜHL, Eltmann (DE)

(21) Appl. No.: 15/623,505

(22) Filed: Jun. 15, 2017

(30) Foreign Application Priority Data
Jun. 16, 2016 (DE) 10 2016 210 741.0

(51) Int. Cl. F16D 3/14; F16D 3/12; F16F 15/129; F16F 15/123; F16D 13/64

(52) U.S. Cl. CPC F16D 3/14; F16F 15/12353; F16D 13/644; F16F 15/123; F16F 15/129; F16D 3/12; F16D 2300/22; F16F 2222/04; F16F 2232/02

(57) ABSTRACT

A Torsion damper wherein
a first group of friction rings is supported in circumferential direction so as to be stationary with respect to the torque output part,
and a second group of friction rings is supported in circumferential direction in the first swivel angle range so as to be moveable relative to the torque input disk and torque output disk,
and in the second swivel angle range the second group of friction rings is supported in circumferential direction in a driving connection with respect to the torque input disk and executes a synchronous rotational movement with the torque input disk,
wherein in the second swivel angle range a relative movement in circumferential direction takes place between the torque output disk and the second friction ring group, and a relative movement in circumferential direction takes place between the torque input disk and the first friction ring group.

### FIELD OF THE INVENTION

The present invention is directed to a torsion damper with a friction device dependent on the swivel angle.

### BACKGROUND OF THE INVENTION

Conventional friction devices not infrequently have the problem of premature failure. Most friction devices operate with constant friction torque and/or constant damping over the entire torsion damper characteristic or are adjusted to a range of characteristics or a spring level. For this purpose, control plates engage in the spring windows or at least have control edges for the springs, e.g., U.S. Pat. No. 7,559,844. However, the level of required friction torque is determined only by the required damping of the powertrain resonance in the respective gear of the transmission. The higher the resonance, the higher the required damping (i.e., friction torque) and, therefore also, the higher the loading of the friction device. The load manifests itself conventionally in higher forces (usually disk springs) and, therefore, higher area pressures in the contact points of the friction device.

An obvious idea could be simply to increase the wear volume of the friction device. The wear volume is formed by at least one friction ring which is axially loaded. The friction ring is often part of a series arrangement between two torque transmission disks which are spaced apart axially from one another. For reasons relating to installation space, the aim is for the spacing between the torque transmission disks to be as small as possible. Consequently, the wear volume is also limited because the radial installation space is limited.

### SUMMARY OF THE INVENTION

It is thus an object of the present invention to minimize wear problems in connection with a friction device.

This object is met in that
a first group of friction rings is supported in circumferential direction so as to be stationary with respect to the torque output part,
and a second group of friction rings is supported in circumferential direction in the first swivel angle range so as to be moveable relative to the torque input disk and torque output disk,
and in the second swivel angle range the second group of friction rings is supported in circumferential direction in a driving connection with respect to the torque input disk and executes a synchronous rotational movement with the torque input disk,
wherein in the second swivel angle range a relative movement in circumferential direction takes place between the torque output disk and the second friction ring group and a relative movement in circumferential direction takes place between the torque input disk and the first friction ring group.

The great advantage consists in that the friction device takes effect with priority only in the operating state of the torsion damper when a friction damping is also needed. Consequently, the wear volume of the friction device can be used in a more purposeful manner and can now advantageously cover the entire lifetime, e.g., of a vehicle clutch without being increased.

In a further advantageous embodiment, it is provided that friction rings of the first group are in direct axial contact with friction rings of the second group and a friction torque is generated at the contact points in the second swivel angle range. An appreciable increase in friction torque can be achieved through the direct contact without increasing the wear volume of the friction ring groups.

A further step for controlling friction torque consists in that the two friction ring groups have different friction coefficients. A certain base friction is also present in the first swivel angle range. The difference in friction forces between the two swivel angle ranges can be appreciably enhanced through the use of a friction ring group of plastic or with a Teflon coating, for example.

In a further advantageous embodiment, two torque output disks are connected to one another via an arrangement of fastening device, the spacing bolts thereof forming a way for preventing rotation for the first friction ring group. Consequently, there is no need for additional devices to prevent rotation.

According to an advantageous embodiment, the torque input disk has a quantity of driving pins which engage in cutouts of the second friction ring group with a circumferential clearance corresponding to the first swivel angle range. Consequently, there is a direct connection between the torque input disk and the second friction ring group.

In order that the transition between the two swivel angle ranges is as noiseless as possible, a spring element is arranged between the driving pins and the cutouts.

The spring element is preferably formed by an elastomeric body.

In one embodiment, the driving pin supports the spring element, for example, within the scope of a coating. This obviates the need for securing the spring element. Alternatively, the spring element can also be clamped in the cutout. To this end, a ring element is simply produced and is pressed into the cutout.

In a further advantageous embodiment, the driving pin is formed by a bolt. In this case, there would be no need for punching out the torque input disk, which could weaken it.

To prolong the life of the torque output disk, but also to achieve friction torques which are more easily reproducible, the torque output disk is carried out with a wear protection disk in axial direction of the friction ring groups.

In a further advantageous embodiment, the wear protection disk is supported in circumferential direction in a stationary manner with respect to the torque output disk. This also ensures an unwanted relative movement between the wear protection disk and the torque output disk.

As a further step for a defined friction torque adjustment, a spring arrangement exerts an axial preloading force on the friction device. In principle, the friction device could also be outfitted without a spring in that, e.g., the axial installation space is exactly tailored to the series arrangement of the participating component parts so that all of the component parts are axially preloaded. However, this mode of construction would be considerably more dependent on manufacturing tolerances.

### BRIEF DESCRIPTION OF THE DRAWINGS

The invention will be described more fully referring to the following drawings in which:

FIG. 1 is a partial top view of a torsion damper with friction lining of the present invention;

FIGS. 2-5 are sectional views through the torsion damper of FIG. 1; and

FIG. 6 is an enlarged sectional view from FIG. 1.

### DETAILED DESCRIPTION OF THE PRESENTLY PREFERRED EMBODIMENTS

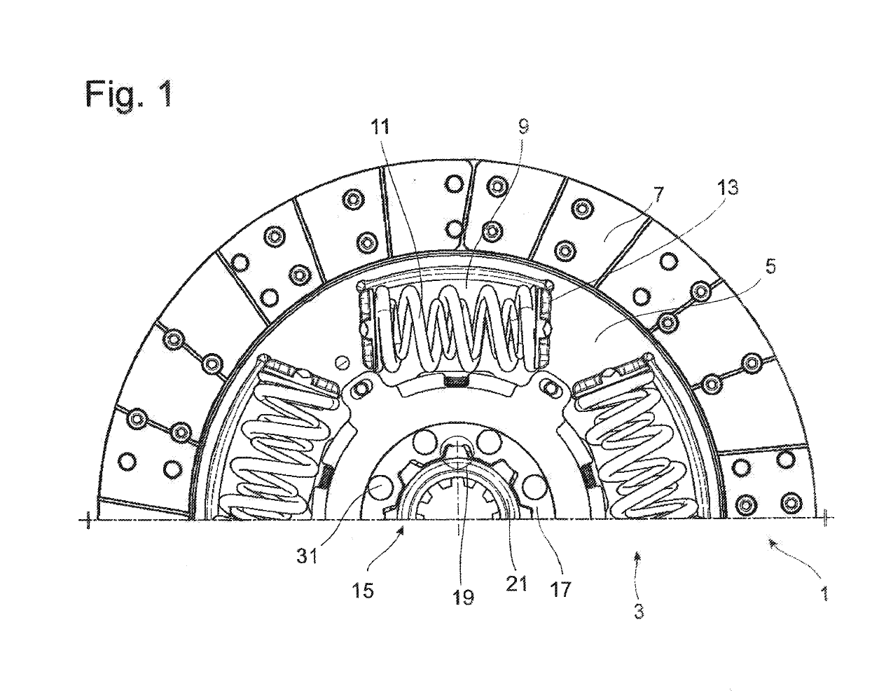

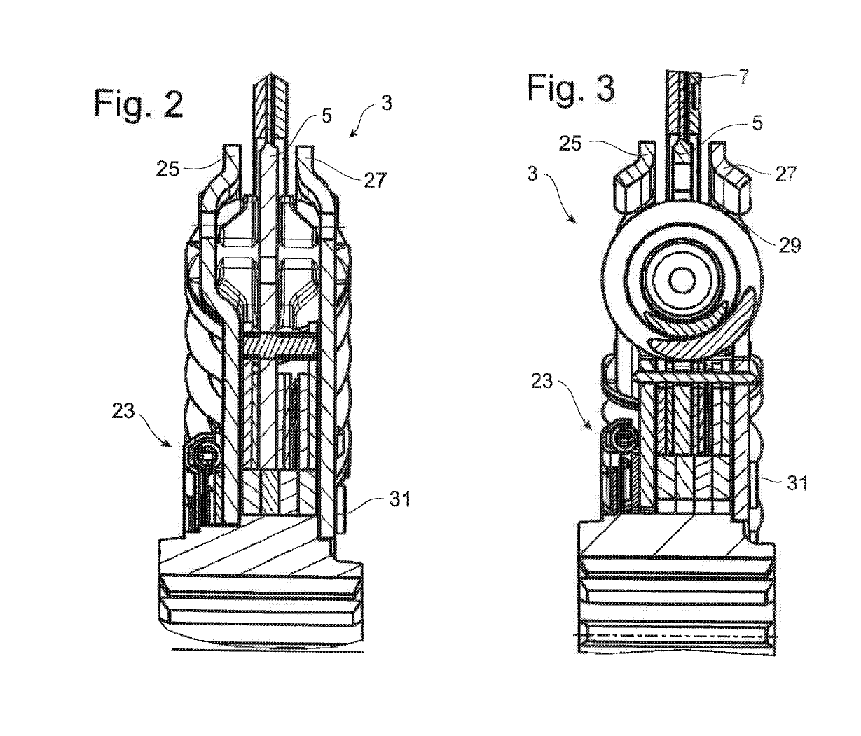

FIG. 1 shows a top view of a partially assembled clutch disk 1 with a torsion damper 3. In principle, the torsion damper can also be applied outside of a clutch disk. It is clear when viewed together with FIGS. 2 and 3 that the torsion damper 3 has a torque input disk 5 which carries a friction lining 7. A torque of a drive motor, for example, is transmitted via a clutch housing, not shown, to the friction lining on this torque input disk 5.

The torque input disk 5 has window-like recesses 9 in which is arranged at least one spring storage 11, e.g., a helical compression spring. In the present example, a supporting disk 13 is inserted between end turns of the helical compression spring 11 and the recess 9.

The torque input disk 5 is centered over its inner diameter with respect to a torsion damper hub 15. For example, the torsion damper hub 15 is constructed so as to be divided in that an outer ring 17 can execute a defined displacing movement in circumferential direction. A connection to an inner hub is made via a tooth profile 19. The relative movement between the outer ring 17 and the inner hub 21 is cushioned via a so-called pre-damper. The functioning and construction of the pre-damper 23 are known, for example, from DE 199 58 326 A1, the entire content of which is hereby incorporated by reference. The pre-damper 23 and the divided torsion damper hub are optional.

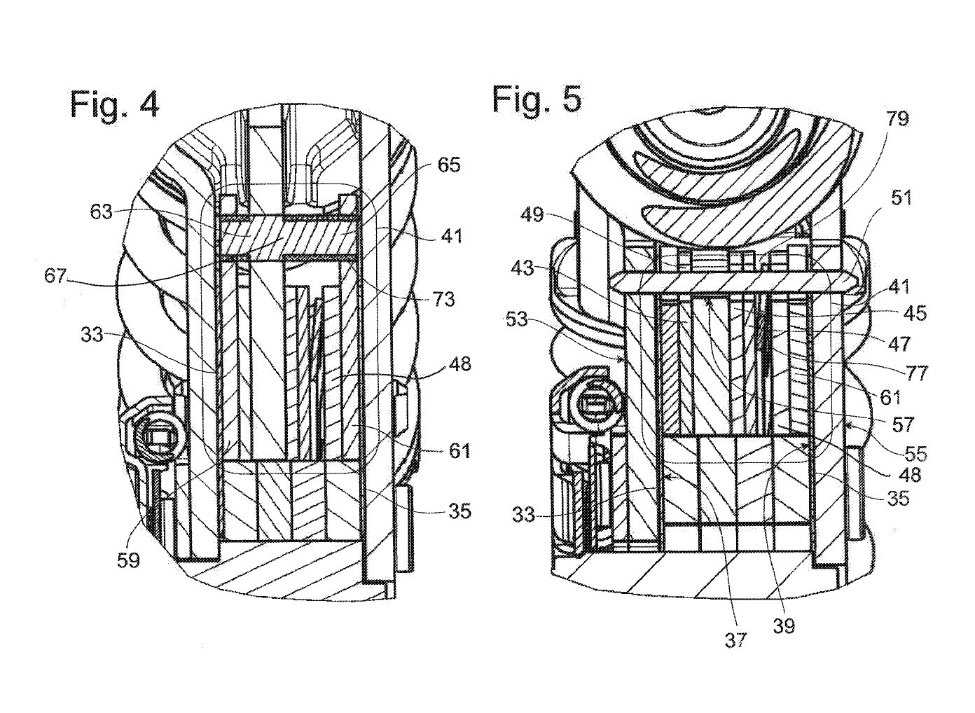

Further, the torsion damper 3 comprises two torque output disks 25; 27 which are arranged on both sides of the torque input disk 5. The torque output disks 25; 27 also have window-like recesses 29 into which the spring storages 11 extend. Depending on the dimensioning of spring storages 11 and window-like recesses 9; 29 in the torque input disk 5 and torque output disks 25; 27, the two disk groups can move relative to one another in circumferential direction. The two torque output disks 25; 27 are rigidly connected to the outer ring 17, for example, via a rivet connection 31, axially and in circumferential direction. A wear protection disk 33; 35 can optionally be arranged on both sides of the outer ring 17. This wear protection disk 33; 35 is captured by the rivet connection 31 so that the wear protection disks 33; 35 are supported in circumferential direction so as to be stationary with respect to the torque output disk 25; 27. The wear protection disks 33; 35 face with their friction surface 37; 39 in direction of the torque input disk 5 (see FIGS. 4 and 5).

The relative movement between torque input disk 5 and the torque output disks is damped by a friction device 41. The friction device 41 comprises a first group of friction rings 43; 45; 47; 48 which are supported in circumferential direction so as to be stationary with respect to the torque output disks 25; 27 and contact the latter directly on both sides of the torque input disk 5. These friction rings 43-48 can be made of a metal material, for example, so as to make use of a high abrasion resistance on the one hand and a comparatively high friction coefficient on the other hand. At their outer diameter area, the friction rings 43; 45; 47; 48 of the first group have a cutout 49 for a spacer bolt 51 which extends transversely through the torsion damper 3 and passes through outer cover surfaces 53; 55 of the torque output disks 25; 27, is possibly staked with the cover surface 53; 55. The cutouts 49 in the friction rings 43-48 are dimensioned in circumferential direction such that a certain play is available for assembly, whereas no additional clearance is provided otherwise.

The torque input disk 5 also has a through-cross section 57 for the spacer bolt 51, which through-cross section 57 is dimensioned in circumferential direction so as to be at least as large as the entire swivel angle of the torsion damper 3.

The torsion damper has a second group of friction rings 59; 61 which is supported in a first swivel angle range of the torsion damper 3 relative to the torque input disk 5 and relative to the torque output disks 25; 27. The friction rings 59; 61 of the second group are arranged in each instance between the friction rings 43-48 of the first group and the torque output disks 25; 27. Insofar as wear protection disks 33; 35 are provided, the friction rings of the second group are located between the wear protection disks 33; 35 and the friction rings 43-48 of the first group. In principle, the friction rings 43-48; 59; 61 of the two friction ring groups can also have different friction coefficients so that, e.g., the friction rings 43-48 of the first group have a lower friction coefficient and for that reason are fashioned from plastic, for example.

The second group of friction rings 59; 61 is controlled via a quantity of driving pins 63; 65 of the torque input disk 5. These driving pins could be shaped directly out of the material of the torque input disk. In this example, however, the driving pins 63; 65 are formed by a separate bolt 67 which is fixedly anchored in the torque input disk. The control of the friction rings 59; 61 is carried out via a driving connection between the driving pin 63; 65 or bolt 67 and cutouts 69 in the friction rings 59; 61 in which the bolts engage. Cutouts 69 are dimensioned in circumferential direction in such a way that the driving connection is not made until a first swivel angle range 71 of the torsion damper 3 is traversed. To prevent impact noises, a spring element 73 is arranged (FIG. 4) between the driving pin 63; 65 or bolt 67 and the cut out. Specifically, the cut out carries an elastomeric body which is preferably formed by a coating. However, it is also possible that the spring element 73 is clamped in the cutout 69 of the friction rings.

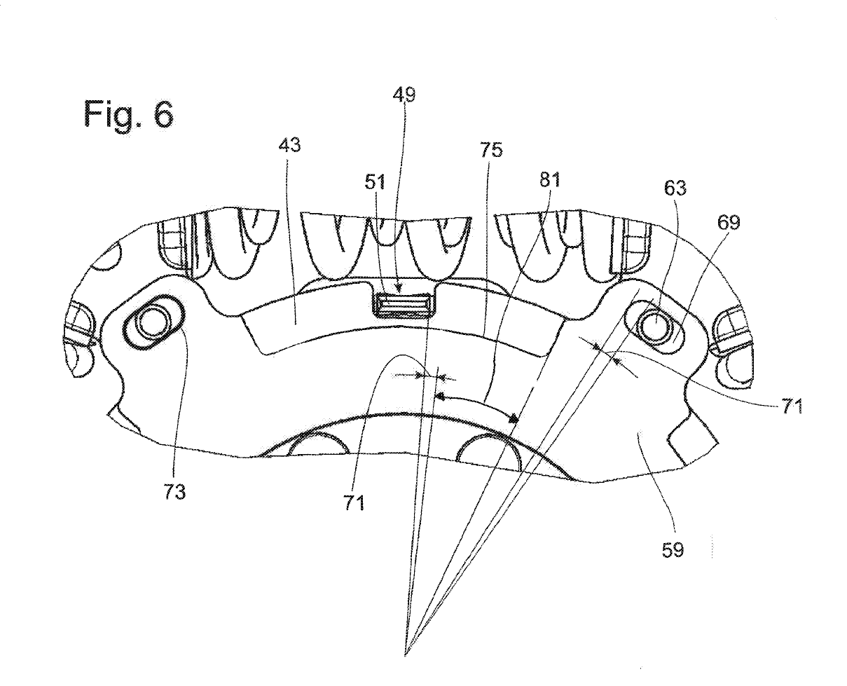

FIG. 6 shows an enlarged detail from FIG. 1. The driving connection with the first swivel angle range 71 and the connection between the spacer bolt 51 and a friction ring 59 of the second group, which connection is fixed with respect to rotation in circumferential direction, can be seen in FIG. 6. Further, a clearance 75 which describes the entire swivel angle in circumferential direction can be seen in the friction ring 59 of the second group.

A spring arrangement 77 in the preferred constructional form of a disk spring exerts an axial preloading force on the entire friction device 41. The two torque output disks 25; 27 form the axial supporting elements. FIGS. 2 to 5 show that the friction devices 41 can also have an odd number of friction rings. For example, two friction rings 45; 47 of the first group are arranged directly adjacent to one another between the disk spring 77 and the torque input disk 5 in order to achieve a defined axial length. The axial installation space 79 and, therefore, the preloading of the disk spring 77 can be determined by this step.

When torque is introduced via the torque input disk 5, the latter rotates in circumferential direction relative to the torque output disks 25; 27. The spring storages 11 form a counter-torque which increases over the entire swivel angle. There is a relative movement between the friction rings of the second group 59; 61 and the torque input disk 5 in the first swivel angle range 71. Consequently, a friction torque caused by the friction device 41 also occurs. The bolt 67 can move in circumferential direction in the first swivel angle range without the friction rings 59; 61 of the second group carrying out a rotational movement. Consequently, the friction rings 59; 61 of the second group in cooperation with the torque output disks 25; 27 do not generate any friction torque and are therefore also not subjected to wear.

When the friction rings 43-48 of the first group have a smaller friction coefficient than the friction rings of the second group, then only a small friction torque is also in effect. When the driving connection between the bolt 67 and the second group of friction rings 59; 61 is closed at the end of the first swivel angle range 71, a second swivel angle range 81 commences and, in addition to the relative movement of the first group 43-48 with the torque input disk 5, there is a relative movement, synchronous with the torque input disk 5, between the friction rings 59; 61 of the second group with the wear protection disks 33; 35 and the friction rings 43-48 of the first group. In addition, friction rings 43 and 48 rub with 59 and 61. Friction rings 59; 61 of the second group have a higher friction coefficient and, owing to the additional two pairs of friction surfaces, the friction torque increases appreciably in the second swivel angle range.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A torsion damper (3) with at least one torque input disk (5) and at least one torque output disk (25; 27), wherein the torque input disk (5) can move in circumferential direction relative to the torque output disk (25; 27) against the force of at least one spring storage (11), wherein the relative movement is damped by a friction device (41) which generates a smaller friction torque in a first swivel angle range (71) than in a second swivel angle range (81) in that the friction device (41) has at least two friction ring groups (43-48; 59; 61) which are rotatable opposite one another and which are activated depending on the swivel angle, the torsion damper comprising:
a first group of friction rings (43-48) supported in circumferential direction so as to be stationary with respect to the torque output part (25; 27);
and a second group of friction rings (59; 61) supported in circumferential direction in the first swivel angle range so as to be moveable relative to the torque input disk (5) and torque output disk (25; 27);
and in the second swivel angle range the second group of friction rings (59; 61) supported in circumferential direction in a driving connection (67; 69) with respect to the torque input disk (5) and constructed to execute a synchronous rotational movement with the torque input disk (5),
wherein in the second swivel angle range (81) a relative movement in circumferential direction taking place between the torque output disk (25; 27) and the second friction ring group (59; 61) and a relative movement in circumferential direction taking place between the torque input disk (5) and the first friction ring group (43-47), and a relative movement taking place between the friction rings of the first to second group (59, 61).

2. The torsion damper according to claim 1, wherein the friction rings of the first group are in direct axial contact with friction rings (59; 61) of the second group and a friction torque is generated at the contact points in the second swivel angle range (81).

3. The torsion damper according to claim 1, wherein the two friction ring groups have a different friction coefficient.

4. The torsion damper according to claim 1, wherein two torque output disks (25; 27) are connected to one another via an arrangement of fastening device comprising spacer bolts (51), for preventing rotation for the first friction ring group (43-47).

5. The torsion damper according to claim 1, wherein the torque input disk (5) has a quantity of driving pins (63; 65) which engage in cutouts (69) of the second friction ring group (59; 61) with a circumferential clearance corresponding to the first swivel angle range (71).

6. The torsion damper according to claim 5, additionally comprising a spring element (73) is arranged between the driving pins (63; 65) and the cutouts (69).

7. The torsion damper according to claim 6, wherein the spring element (73) is formed by an elastomeric body.

8. The torsion damper according to claim 6, wherein the driving pin (63; 65) supports the spring element (73).

9. The torsion damper according to claim 6, wherein the spring element (73) is clamped in the cutout (69).

10. The torsion damper according to claim 5, wherein the driving pin (63; 65) is formed by a bolt (67).

11. The torsion damper according to claim 1, wherein the torque output disk (25; 27) comprising a wear protection disk (33; 35) in axial direction of the friction ring groups (43-47; 59; 61).

12. The torsion damper according to claim 11, wherein the wear protection disk (33-35) is supported in circumferential direction in a stationary manner with respect to the torque output disk (25; 27).

13. The torsion damper according to claim 1, additionally comprising a spring arrangement (77) for exerting an axial preloading force on the friction device (41).
